(19) United States
(12) Patent Application Publication
(10) Pub. No.: US 2011/0128717 A1
(43) Pub. Date: Jun. 2, 2011

(54) UNINTERRUPTIBLE ILLUMINATOR

(76) Inventors: Ching-Nan YANG, Yonghe City (TW); Tsung-Chih Kao, Yonghe City (TW); Chun-Hsin Yang, Yonghe City (TW)

(21) Appl. No.: 12/627,553

(22) Filed: Nov. 30, 2009

(51) Int. Cl. F21V 19/04

(52) U.S. Cl. 362/20

(57) ABSTRACT

An uninterruptible illuminator includes primarily a wireless transmitter and an illuminating drive module. The illuminating drive module contains wireless receivers, a drive module, a power supply device and a recharging device. The wireless transmitter transmits a result that a power signal is detected to the wireless receivers and continues providing the wireless receivers with a message whether the power signal is available, in a certain range of transmission. If the wireless receivers cannot receive the power signal, then the drive module which is connected with the wireless receivers will activate the power supply device to produce electricity to drive a lamp-set to continue producing light. Therefore, by the aforementioned structures, an original operating method in an ordinary power supply system can be maintained; and at a same time, a state of illumination of the illuminator can be maintained.

### BACKGROUND OF THE INVENTION

a) Field of the Invention

The present invention relates to an illuminator and more particularly to an uninterruptible illuminator which maintains an original power supply system and can at a same achieve uninterruptible illumination.

b) Description of the Prior Art

An emergency illuminating apparatus refers generally to an illuminator which can continue providing an illuminating effect when a normal power is interrupted, in order to maintain proper illumination at a home, in a work place or an emergency passage, such that a user can be guided to evacuate successfully after finishing the work in a short time or upon encountering an emergency.

Most of the emergency illuminating apparatuses sold on an existing market are applied at ordinary emergency exits and corners of all corridors. This provision is to still maintain the illuminating effect of certain brightness when the normal power is interrupted, so as to provide an accurate evacuation route. In recent years, as improvement of a living quality at homes, not only a building design should be comfortable, but also a safety consideration should be emphasized.

The emergency illuminating apparatuses on the existing market are mostly emergency illuminating lamps hung on walls and these emergency illuminating lamps are usually installed at necessary passages accessed by many people and at all major evacuation exits.

These emergency illuminating apparatuses are provided with an automatic AC (Alternating Current) to DC (Direct Current) switching device, where in a normal time, an AC power will output a certain amount of DC power to automatically recharge a backup battery and will automatically stop recharging when an electric capacity is full. On the other hand, if a blackout happens, a backup circuit will be switched to automatically, so that a backup power source can supply electricity for emergency illuminating.

The aforementioned emergency illuminating apparatuses are primarily installed independently at each location and belong to circuit systems differing from the original illuminating apparatuses. Therefore, a consumer has to purchase the emergency illuminating apparatus independently and to install the apparatus at a clear place in each evacuation route. However, this emergency illuminating apparatus should be installed on a wall or an emergency door. As a result, light of the emergency illuminating apparatus will be dissipated out from the wall, such that not only a light radiation range will be small, but brightness of the radiation will be lower correspondingly. In addition, an effective and explicit light effect cannot be provided. On the other hand, when many emergency illuminating apparatuses are hung on the walls, an overall repairing fee and maintenance fee will increase correspondingly.

Accordingly, how to solve the aforementioned issues and shortcoming of the prior art is a direction of research and development for improvement by the present inventor and related vendors.

### SUMMARY OF THE INVENTION

The primary object of the present invention is to provide an uninterruptible illuminator which includes primarily a wireless transmitter and an illuminating drive module, wherein the illuminating drive module is composed of wireless receivers, a drive module, a power supply device and a recharging device. The aforementioned wireless transmitter can transmit to the wireless receivers a result that a power signal is detected, and the wireless transmitter will continue providing the wireless receivers with a message whether the power signal is available, in a certain range of transmission. If the wireless receivers cannot receive the power signal, then the drive module which is connected with the wireless receivers will activate the power supply device to produce electricity to drive a lamp-set to continue producing light. Therefore, by the aforementioned structures, an original operating method can be maintained in an ordinary power supply system; and in a same time, a state of illumination of the illuminator can be maintained.

A second object of the present invention is to provide an uninterruptible illuminator which is able to maintain an original indoor electrical wiring and can also achieve a function of uninterruptible emergency illumination.

A third object of the present invention is to provide an uninterruptible illuminator, wherein a same lamp-set can be shared between an ordinary illuminating system and an emergency illuminating system, in order to save the lamp-set and beautify indoor decoration.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

FIG. 2 shows a flow diagram of the present invention wherein an ordinary indoor power line is used.

FIG. 3 shows a flow diagram of the present invention wherein the indoor power line stops supplying electricity.

FIG. 4 shows a schematic view of a state of use of the preferred embodiment of the present invention.

### DETAILED DESCRIPTION OF THE PREFERRED EMBODIMENTS

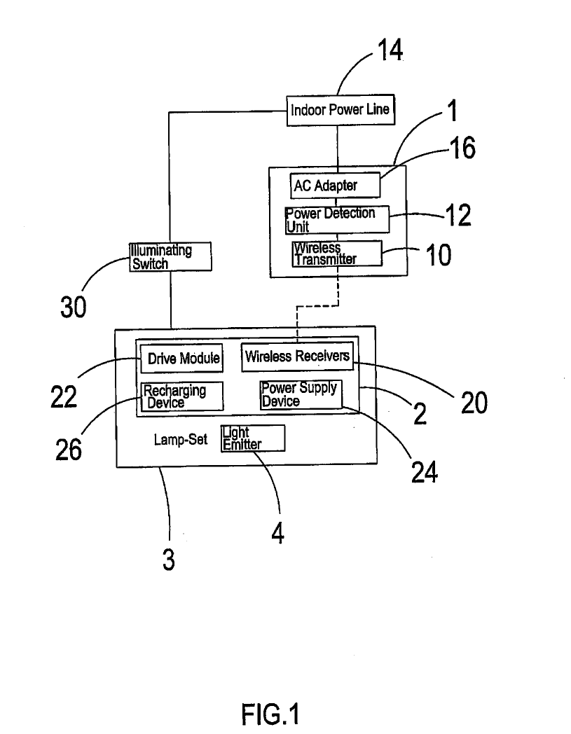

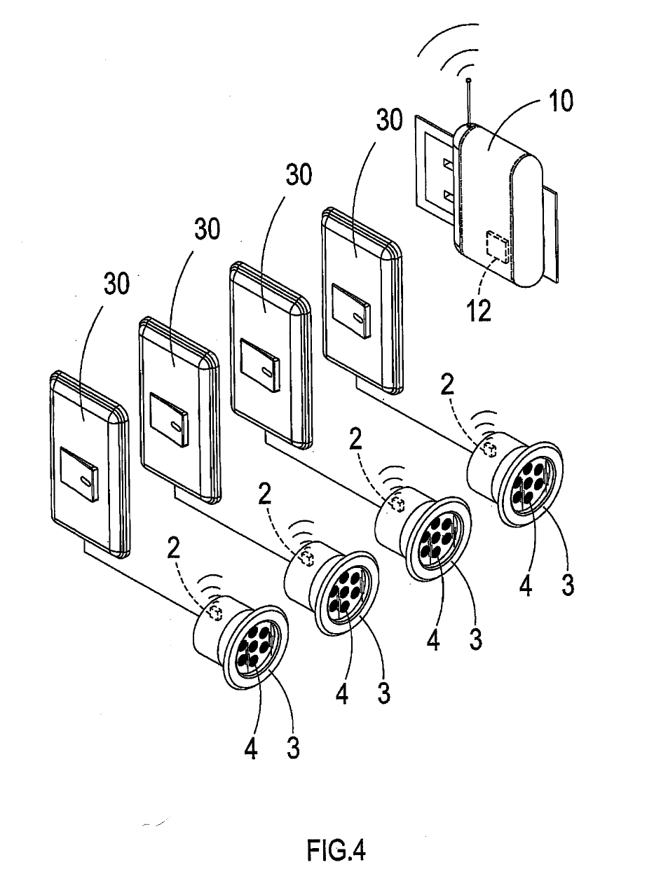

Referring to FIG. 1 and FIG. 4, it shows a block diagram and a schematic view of a state of use, of a preferred embodiment of the present invention. As shown in the drawings, the present invention is an uninterruptible illuminator which comprises primarily a power detection device 1 and an illuminating drive module 2. The power detection module 1 is built in with an AC adapter 16 which is connected with an indoor power line 14, whereas the AC adapter 16 is connected with a power detection unit 12 which detects a power signal and is connected with a wireless transmitter 10. In addition, the illuminating drive module 2 is composed of wireless receivers 20, a drive module 22, a power supply device 24 and a recharging device 26. On the other hand, the illuminating drive module 2 is built into a lamp-set 3 which is installed with at least one light emitter 4 (such as a light emitting diode, a cold and hot cathode tube, a gas discharge lamp or a halogen lamp) and is connected with an illuminating switch 30 to select a state of energizing. The aforementioned wireless transmitter 10, whereas, is provided with the power detection unit 12 and is used to detect whether a power is generated through connecting the power detection unit 12 with the indoor power line 14; in a mean time, the result of detection is transmitted by the wireless transmitter 10 to the wireless receivers 20, with all of the wireless receivers 20, which are covered by a range of the power signal transmitted by the wireless transmitter 10, being able to receive the power signal. Besides, the aforementioned power supply device 24 forms an electric loop with the recharging device 26, so as to maintain an internal power of the power supply device 24.

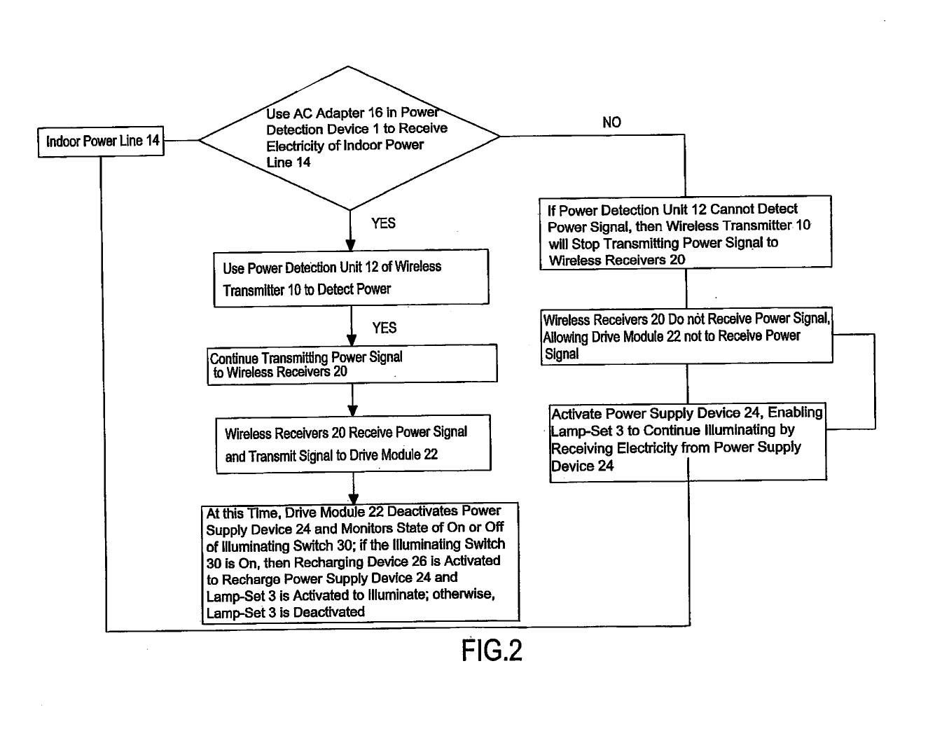

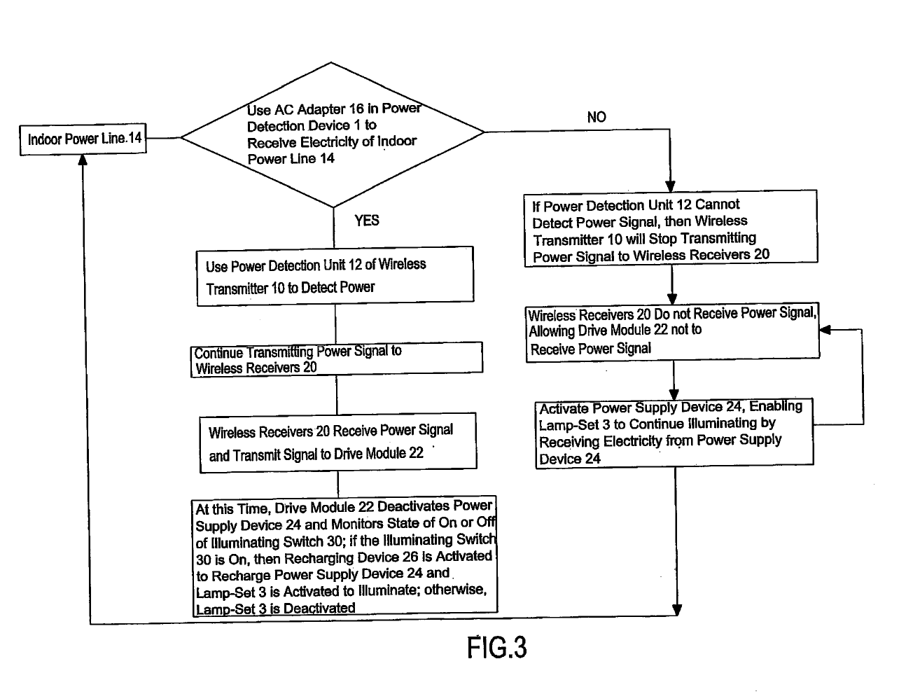

Referring to FIG. 2 and FIG. 3, it shows a flow diagram of the present invention wherein an ordinary indoor power line is used and a flow diagram of the present invention wherein the indoor power line stops supplying electricity. As shown in the drawings, taking an example of that the indoor power line continues providing electricity, as the power detection device 1 is built in with the AC adapter 16 which is connected with the indoor power line 14, the power signal transmitted by the indoor power line 14 can be received. When the AC adapter 16 detects an electric current of the ordinary indoor power line 14, the power detection unit 12 which is connected with the wireless transmitter 10 will detect the power state of the indoor power line 14; and at this time, the wireless transmitter 10 will continuously transmit the power signal to the wireless receivers 20.

On the other hand, the illuminating switch 30 which is connected with the lamp-set 3 can provide a user to select a state of energizing. When the illuminating switch 30 is activated, the lamp-set 3 will at a same time receive electricity supplied by the indoor power line 14 to produce light and will activate the recharging device 26 simultaneously. In addition, through the recharging device 26, the internal power of the power supply device 24 is increased and maintained.

Taking an example that the indoor power line stops supplying electricity, when the wireless transmitter 10 is connected to the ordinary power line 14, detects through the power detection unit 12 and is unable to detect the power of the indoor power line 14, the wireless transmitter 10 will stop outputting the power signal. Therefore, the wireless receivers 20 cannot receive the power signal correspondingly.

When the wireless receivers 20 are unable to receive the source of the power signal within a pre-determined time period, the drive module 22 in the illuminating drive module 2 will activate the power supply device 24 to keep the lamp-set 3 providing light, using the power in the power supply device 24. As a result, the state of illumination of the lamp-set 3 can be maintained. At a same time, the AC adapter 16 will continue detecting the indoor power line 14; and if the AC adapter 16 detects the power from the indoor power line 14, then the power detection device 1 will operate again.

Referring to FIG. 4, it shows the schematic view of the state of use of the preferred embodiment of the present invention. As shown in the drawing, along with FIG. 1, as the illuminating drive module 2 is built into the lamp-set 3 and the lamp-set 3 is installed with at least one light emitter 4, such as a light emitting diode, the user can use the original indoor power wiring as a basis of power supply, in collaboration with the lamp-set 3 which complies with specifications of the indoor power wiring, to achieve a function of uninterruptible illumination. Moreover, the lamp-set can be saved and indoor decoration can be beautified. In addition to the aforementioned advantages, the user can replace the lamp-set 3 which is provided with the illuminating drive module 2 at any time, depending upon a quantity to be used. As the wireless receivers 20 which are covered in the range of power signal transmitted by the wireless transmitter 10 can all receive the power signal, a stability of uninterruptible illumination of the lamp-set 3 can be effectively controlled, thereby assuring that the lamp-set 3 can maintain the state of uninterruptible illumination.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An uninterruptible illuminator comprising:
a power detection device, which is built in with an AC (Alternating Current) adapter to connect an indoor power line, with the AC adapter being connected with a power detection unit to detect a power signal and connect a wireless transmitter; and
an illuminating drive module which is built into a lamp-set, with the lamp-set being electrically connected with the indoor power line, and
the illuminating drive module including wireless receivers to receive a power signal transmitted by the wireless transmitter, a drive module being electrically connected with the wireless receivers to activate a power supply device to produce electricity to the lamp-set, and a recharging device forming an electric loop with the power supply device to maintain an internal power of the power supply device.

2. The uninterruptible illuminator according to claim 1, wherein the lamp-set is connected with an illuminating switch to select a state of energizing.

3. The uninterruptible illuminator according to claim 1, wherein a range of power signal transmitted by the wireless transmitter covers at least one wireless receiver.

4. The uninterruptible illuminator according to claim 1, wherein the lamp-set is provided with at least one light emitter.

5. The uninterruptible illuminator according to claim 4, wherein the light emitter is a light emitting diode.

6. The uninterruptible illuminator according to claim 4, wherein the light emitter is a cold and hot cathode tube.

7. The uninterruptible illuminator according to claim 4, wherein the light emitter is a gas discharge lamp.

8. The uninterruptible illuminator according to claim 4, wherein the light emitter is a halogen lamp.
